(19) United States
(12) Patent Application Publication
(10) Pub. No.: US 2014/0159958 A1
(43) Pub. Date: Jun. 12, 2014

(54) Beam Forming Antenna Array

(71) Applicant: FUTUREWEI TECHNOLOGIES, INC., Plano, TX (US)

(72) Inventor: Dedi D. Haziza, Los Gatos, CA (US)

(73) Assignee: FUTUREWEI TECHNOLOGIES, INC., Plano, TX (US)

(21) Appl. No.: 13/708,554

(22) Filed: Dec. 7, 2012

(51) Int. Cl. H01Q 3/24

(52) U.S. Cl. CPC H01Q 3/247
USPC 342/374

(57) ABSTRACT

A wireless access point device comprising a microcontroller unit, a transceiver coupled to the microcontroller unit, and a beam forming antenna coupled to the transceiver, wherein the beam forming antenna comprises a reflector, a switch, and two or more antenna elements substantially adjacent to the reflector and each coupled to the switch. Included is a beam forming method comprising identifying one or more target users, determining an antenna configuration, activating one or more antenna elements each comprising a reflector, thereby focusing an antenna radio frequency pattern towards the target users, and communicating with the target users, thereby transmitting data to the target users or receiving data from the target users.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

As wireless local access network (WLAN) and WiFi technologies evolve, the demand increases to support a higher capacity (e.g., more users) while maintaining throughput and quality of service (QoS). Additionally, as the number of users and user terminals increases the hostility of the transmission environment may also increase, which may result in more interference, spectral inefficiencies, and lower data throughput for individual users. For example, in a multi-user broadband wireless (e.g., WiFi) environment (e.g., a business center, an office, a hotel, a hospital, etc.), each user may act as a source of noise (e.g., interference) for other users in a conventional WLAN comprising an omnidirectional antenna system. In such an example, data throughput for each user may be reduced because of interference the. Additionally, due to spectral inefficiencies and bandwidth limitations the data throughput for each user may be further reduced.

Conventional WLAN devices, systems, and methods may employ a beam forming antenna system to improve the efficiency (e.g., spectral efficiency, data throughput, etc.) of the system and to alleviate the hostility of the transmission environment. For example, a beam forming antenna system may be employed to direct and/or to focus an antenna radio frequency (RF) pattern towards one or more specific users. Conventional beam forming approaches are often complex, large, and inefficient. For example, conventional WLAN devices, system, and methods comprising a beam forming antenna system may require designing directive antenna elements and/or comprise one or more active circuits (e.g., amplifiers, phase shifting circuits, etc.). Additionally, conventional beam forming methods may experience performance degradation in an indoor multipath environment, for example, due to multipath distortion. Such conventional methods may employ predetermined antenna RF patterns and may not the ability to reconfigure the antenna RF patterns. As such, devices, systems, and methods for more efficiently providing the ability to adjust and/or to steer an antenna RF pattern towards one or more target users are needed.

### SUMMARY

Disclosed herein is a wireless access point device comprising a microcontroller unit, a transceiver coupled to the microcontroller unit, and a beam forming antenna coupled to the transceiver, wherein the beam forming antenna comprises a reflector, a switch, and two or more antenna elements substantially adjacent to the reflector and each coupled to the switch.

Also disclosed herein is a beam forming method comprising identifying one or more target users, determining an antenna configuration, activating one or more antenna elements each comprising a reflector, thereby focusing an antenna radio frequency pattern towards the target users, and communicating with the target users, thereby transmitting data to the target users or receiving data from the target users.

Further disclosed herein is a wireless access point device comprising a microcontroller unit, a transceiver coupled to the microcontroller unit, a beam forming antenna coupled to the transceiver, wherein the beam forming antenna comprises a reflector, two or more antenna elements substantially adjacent to the reflector, and a switch coupled to each antenna element, wherein the switch is configured to control the power to the antenna elements such that an RF pattern produced by the antenna elements is modified by turning on or off the antenna elements, and a memory coupled to the microcontroller, wherein the memory comprises instructions that cause the microcontroller to identify one or more target users, determine an antenna configuration, activate one or more antenna elements each comprising a reflector, thereby focusing an antenna radio frequency pattern towards the target users, and communicate with the target users, thereby transmitting data to the target users or receiving data from the target users.

### BRIEF DESCRIPTION OF THE DRAWINGS

For a more complete understanding of this disclosure, reference is now made to the following brief description, taken in connection with the accompanying drawings and detailed descriptions, wherein like reference numerals represent like parts.

FIG. 1 is a schematic diagram of an embodiment of a portion of a WLAN device;

FIG. 2 is a perspective view of an embodiment of a beam forming antenna array;

FIG. 3 is a side view of an embodiment of a beam forming antenna array;

FIG. 4 is a top view of an embodiment of a beam forming antenna array;

FIG. 5 is a perspective view of an embodiment of a beam forming antenna array radio frequency pattern;

FIG. 6 is a top view of an embodiment of a beam forming antenna array communicating with a single user;

FIG. 7 is a top view of another embodiment of a beam forming antenna array communicating with a single user;

FIG. 8 is a top view of an embodiment of a beam forming antenna array communicating with two users;

FIG. 9 is a top view of an embodiment of a beam forming antenna array communicating with four users; and

FIG. 10 is a flow chart of an embodiment of a beam forming method.

### DETAILED DESCRIPTION OF THE EMBODIMENTS

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are embodiments of a beam forming antenna array (BFAA), a WLAN device comprising a BFAA, and methods using the same. In an embodiment, the BFAA may be employed to provide the ability to adjust and/or to steer an antenna RF pattern towards one or more target users, thereby improving data throughput and improving spectral efficiency of the WLAN device, as will be disclosed herein. Additionally, the BFAA may be further configured to provide omni-directional coverage to one or more target users, when so configured, as will be disclosed herein.

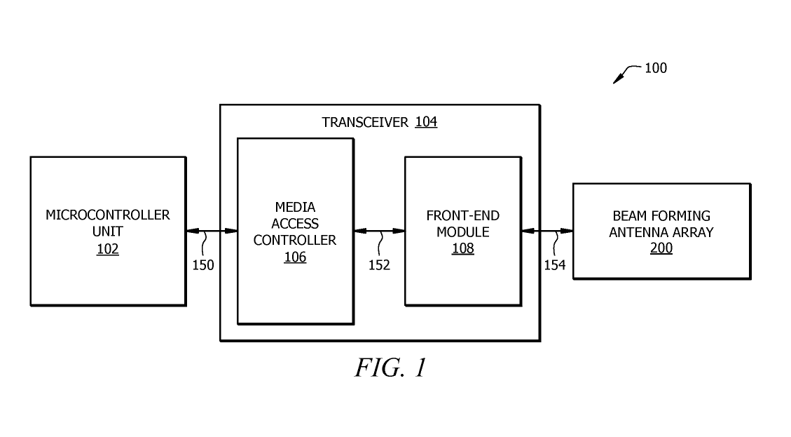

Referring to FIG. 1, an embodiment of an operating environment of a BFAA is illustrated. In an embodiment, the operating environment generally comprises a plurality of functional units associated with a WLAN device, as will be disclosed herein.

In an embodiment as illustrated in FIG. 1, the WLAN device 100 may comprise a plurality of functional units. In an embodiment, a functional unit (e.g., an integrated circuit (IC)) may perform a single function, for example, serving as an amplifier or a buffer. The functional unit may perform multiple functions on a single chip. The functional unit may comprise a group of components (e.g., transistors, resistors, capacitors, diodes, and/or inductors) on an IC which may perform a defined function. The functional unit may comprise a specific set of inputs, a specific set of outputs, and an interface (e.g., an electrical interface, a logical interface, and/or other interfaces) with other functional units of the IC and/or with external components. In some embodiments, the functional unit may comprise repeat instances of a single function (e.g., multiple flip-flops or adders on a single chip) or may comprise two or more different types of functional units which may together provide the functional unit with its overall functionality. For example, a microprocessor or a microcontroller may comprise functional units such as an arithmetic logic unit (ALU), one or more floating-point units (FPU), one or more load or store units, one or more branch prediction units, one or more memory controllers, and other such modules. In some embodiments, the functional unit may be further subdivided into component functional units. A microprocessor or a microcontroller as a whole may be viewed as a functional unit of an IC, for example, if the microprocessor shares circuit with at least one other functional unit (e.g., a cache memory unit).

The functional units may comprise, for example, a general purpose processor, a mathematical processor, a state machine, a digital signal processor, a video processor, an audio processor, a modem, a radio, a receiver, a transmitter, a transceiver, a logic unit, a logic element, a multiplexer, a demultiplexer, a switching unit, a switching element an input/output (I/O) element, a peripheral controller, a bus, a bus controller, a register, a combinatorial logic element, a storage unit, a programmable logic device, a memory unit, a neural network, a sensing circuit, a control circuit, a digital to analog converter, an analog to digital converter, an oscillator, a memory, a filter, an amplifier, a mixer, a modulator, a demodulator, and/or any other suitable devices as would be appreciated by one of ordinary skill in the art.

In the embodiments of FIG. 1, the WLAN device 100 may comprise a plurality of distributed components and/or functional units and each functional unit may communicate with one or more other functional units via a suitable signal conduit, for example, via one or more electrical connections, as will be disclosed herein.

In the embodiment of FIG. 1, the operating environment comprises WLAN device 100 comprising a plurality of interconnected functional units, for example, for transmitting and/or receiving one or more RF signals (e.g., WiFi signals). In the embodiment of FIG. 1, a WLAN device 100 may generally comprise various functional units including, but not limited to a microcontroller unit (MCU) 102, a transceiver 104, and a BFAA 200, arranged as shown in FIG. 1. In such an embodiment, the WLAN device 100 is configured to transmit and/or to receive a RF signal (e.g., a WiFi signal) (e.g., to/from one or more target users). While FIG. 1 illustrates a particular embodiment of an operating environment in which a BFAA 200 may be employed and/or a particular configuration of functional units with which a BFAA 200 may be associated, upon viewing this disclosure one of ordinary skill in the art will appreciate that a BFAA 200 as will be disclosed herein may be similarly employed in alternative operating environments and/or with alternative configurations of WLAN device functional units.

In an embodiment, the MCU 102 may be configured to control one or more functional units of the WLAN device 100 and/or to control data flow through the WLAN device 100. For example, the MCU 102 may be configured to communicate one or more electrical signals (e.g., data packets) with the transceiver 104 (e.g., via electrical connection 150) and/or to perform one or more processes on the electrical signals (e.g., authentication, packet monitoring logic, etc.). In such an embodiment, one or more of the processes may be performed in software, hardware, or a combination of software and hardware.

In an embodiment, the MCU 102 may comprise a processor core, a logical unit (LU), a memory storage device, input/output (I/O) peripherals, a digital signal processor (DSP), and/or any other suitable functional units as would be appreciated by one of ordinary skill in the art upon viewing this disclosure. For example, in an embodiment, the LU may be configured to perform arithmetic operations and/or logical operations, for example, logical operations on an electrical signal from a transceiver. Additionally, in an embodiment, the memory storage device may be generally configured to store information (e.g., data) for the WLAN device 100 and may be configured to read and/or to write data to one or more memory cells of the memory storage device. In an embodiment, the memory storage device may comprise a read only memory (ROM), a random access memory (RAM), a flash memory, an external memory (e.g., a secure digital (SD) card), any suitable type of memory device as would be appreciated by one of ordinary skill in the art upon viewing this disclosure, or combinations thereof. Additionally, in an embodiment, the I/0 peripherals may be generally configured to transmit electrical signals and/or data signals between the MCU 102 and/or the WLAN device 100 and external hardware (e.g., an electrical outlet, a computer, etc.). Further, in an embodiment, the DSP may be configured to manipulate, to modify, and/or to improve an electrical signal, for example, an electrical signal from a transceiver.

In an embodiment, the transceiver 104 may be configured to conform to Institute of Electrical and Electronics Engineers (IEEE) 802.11 and/or 802.16 standards and/or protocols. In an additional or alternative embodiment, the transceiver 104 may be configured to conform to any other suitable standards and/or protocols as would be appreciated by one of ordinary skill in the arts upon viewing this disclosure.

In an embodiment, the transceiver 104 may be generally configured to support and/or to provide wireless communications to/from the WLAN device 100 (e.g., via the BFAA 200). In an embodiment, the transceiver 104 may generally comprise a media access controller (MAC) 106 and a front-end module (FEM) 108.

In an embodiment, the MAC 106 may be generally configured to communicate an electrical signal (e.g., a data signal) with the MCU 102 (e.g., via an electrical connection 150) and to communicate a MAC layered data signal with the FEM 108 (e.g., via electrical connection 152). In an embodiment, the MAC 106 may be generally configured to provide addressing and/or to provide channel access control mechanisms (e.g., for controlling data signal traffic). For example, the MAC 106 may be configured to implement a carrier sense multiple access (CSMA) protocol, a carrier sense multiple access with collision avoidance (CSMA/CA) protocol, a carrier sense multiple access with collision detection (CSMA/CD) protocol, a carrier sense multiple access with collision avoidance and resolution using priorities (CSMA/CARP) protocol, multiple access with collision avoidance (MACA) protocol, multiple access with collision avoidance for wireless (MACAW) protocol, a pure ALOHA protocol, a slotted ALOHA protocol, a reservation ALOHA (R-ALOHA) protocol, a mobile slotted ALOHA (MS-ALOHA) protocol, a dynamic time division multiple access (TDMA) protocol, a distributed coordination function (DCF), a point coordination function (PCF), a hybrid coordination function (HCF), or any other suitable media access protocol as would be appreciated by of ordinary skill in the art upon viewing this disclosure.

In an embodiment, the FEM 108 may be generally configured to communicate a MAC layered data signal with the MAC 106 (e.g., via electrical connection 152) and to communicate a physical signal with the BFAA 200 (e.g., via electrical connection 154). In an embodiment, the FEM 108 may be generally configured to filter an electrical signal (e.g., a MAC layered data signal), to amplify an electrical signal, to mix an electrical signal (e.g., up-convert an electrical signal or down-convert an electrical signal), to modulate an electrical signal, to control or configure an electrical current flow path (e.g., open or close one or more antenna switches), any other suitable signal processing as would be appreciated by one of ordinary skill in the art upon viewing this disclosure, or combination thereof. Additionally, in an embodiment, the FEM 108 may be configured to modulate an electrical signal, for example, to implement frequency hopping spread spectrum (FHSS) modulation, direct sequence spread spectrum (DSSS) modulation, orthogonal frequency division multiplexing (OFDM), high rate direct sequence spread spectrum (HR-DSSS), or any other suitable modulation technique as would be appreciate by one of ordinary skill in art upon viewing this disclosure.

In the embodiment of FIG. 1, the BFAA 200 may be configured to interface and/or to couple to the transceiver 104 and/or FEM 108 (e.g., via electrical connection 154) and to receive and/or to transmit a RF signal (e.g., WiFi signal) to/from the WLAN device 100.

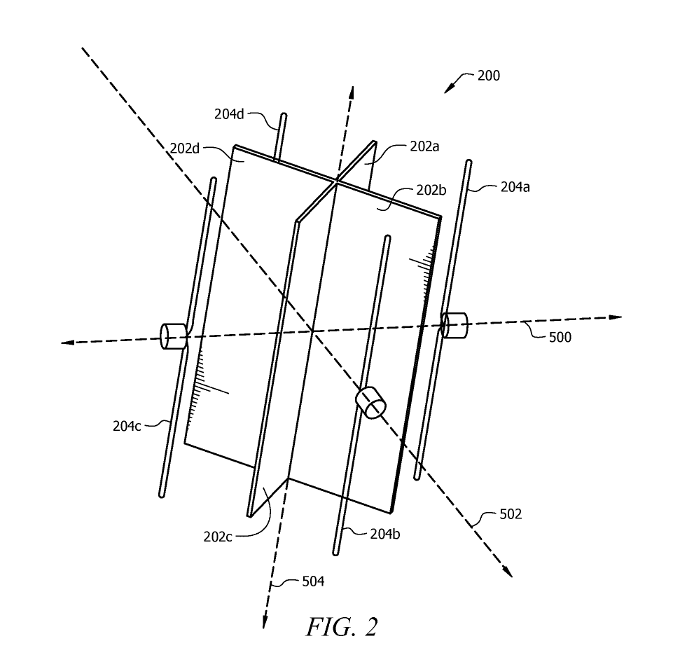

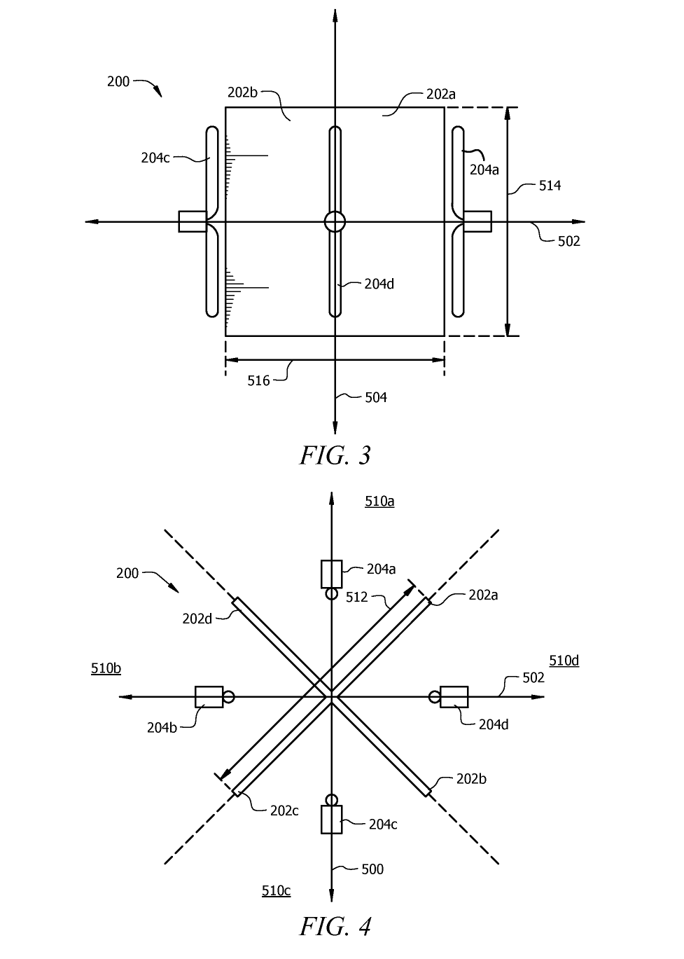

In the embodiment of FIGS. 2, 3, and 4, the BFAA 200 may general comprise a reflector 202 and a plurality of antenna elements 204 (e.g., antenna elements 204a-204d). In an embodiment, the reflector 202 may generally comprise a material suitable for reflecting at least a portion of a RF signal, for example, an RF signal transmitted by one or more antenna elements 204. For example, in an embodiment, the reflector 202 may generally comprise a solid metal surface and/or a wire metal surface, for example, a material formed of aluminum, copper, gold, any other suitable conductive material, as would be appreciated by one of ordinary skill in the art upon viewing this disclosure, or combination thereof. In an embodiment, the reflector 202 may comprise one or more folds and/or two or more segments (e.g., metal surfaces) joined along one or more edges of each of the segments. For example, in the embodiment of FIG. 2, the reflector 202 may comprise four solid metal surface segments (e.g., reflector segments 202a-202d) positioned about perpendicular (e.g., about 90 degrees) with respect to each other and may be joined along a common edge (e.g., along a vertical axis 504). In such an embodiment, as illustrated in FIG. 4, the reflector 202 (e.g., the reflector segments 202a-202d) may be configured to partition a horizontal plane (e.g., a plane defined by a first horizontal axis 500 and a second horizontal axis 502) into a plurality of sectors (e.g., sectors 510a-510d). In an alternative embodiment, a reflector may comprise 6 segments, 8 segments, 10 segments, 12 segments, or any other number of segments as would be appreciated by one of ordinary skill in the art upon viewing this disclosure. Additionally or alternatively, a reflector may span less than a complete circle, e.g. about 90 degrees, about 180 degrees, or about 270 degrees, or may span a complete circle, e.g. about 360 degrees. In embodiments, the reflector (e.g., the plurality of reflector segments) may further divide the horizontal plane into additional sectors, thereby increasing the resolution or granularity of the horizontal plane that can be addresses, as will be disclosed herein. Additionally in an embodiment, the reflector 202 structure and/or shape may be configured to be cylindrical, spherical, parabolic, or any other suitable shape as would be appreciated by one of ordinary skill in the art upon viewing this disclosure. In an embodiment, as shown in FIG. 4, the width of a cross section 512 of the reflector 202 may be about 50 millimeters (mm), 25 mm, 75 mm, 100 mm, or any other suitable width as would be appreciated by one of ordinary skill in the art upon viewing this disclosure. Additionally, as shown in FIG. 3, the height 514 of the reflector 202 may be about 64 mm, 32 mm, 75 mm, 100 mm, 200 mm, or any other suitable length as would be appreciated by one of ordinary skill in the art upon viewing this disclosure.

In an embodiment, the antenna elements 204 may be configured to transmit and/or to receive a RF signal (e.g., a WiFi signal) and to be responsive to one or more predetermined frequency bands. For example, the antenna elements 204 may be configured to be responsive to a RF signal (e.g., a WiFi signal) within a predetermined frequency band, for example, a frequency band as defined by the IEEE 802.11 standard (e.g., the 2.4-gigahertz (GHz) band or the 5 GHz band). In an additional or alternative embodiment, the antenna elements 204 may be configured to be responsive to any other suitable frequency band as would be appreciated by one of ordinary skill in the art upon viewing this disclosure. In an embodiment, the antenna elements 204 may generally comprise a monopole antenna, a dipole antenna, a folded dipole antenna, a patch antenna, a microstrip antenna, a loop antenna, an omnidirectional antenna, a planar inverted-F antenna (PIFA), a folded inverted conformal antenna (FICA), any other suitable type and/or configuration of antenna as would be appreciated by one of ordinary skill in the art upon viewing this disclosure, or combinations thereof. In the embodiments of FIGS. 2, 3, and 4, the BFAA 200 may generally comprise four dipole antenna elements 204a-204c. In an alternative embodiment, a BFAA may comprise any suitable number and/or type of antenna elements as would be appreciated by one of ordinary skill in the art upon viewing this disclosure. In an embodiment, for example as illustrated in FIG. 4, one or more antenna elements 204 (e.g., antenna elements 204a-204d) may be positioned within and/or substantially adjacent to one or more sectors (e.g., sectors 510a-510d) defined by the reflector 202, as previously disclosed. In an embodiment, as shown in FIG. 3, the antenna elements 204 may have a spacing 516 of about 62.5 mm, 31.5 mm, 20 mm, 75 mm, or any other suitable spacing as would be appreciated by one of ordinary skill in the art upon viewing this disclosure. Additionally, the antenna elements 204 and the reflector 202 may not be in direct contact with each other and may be separated by air. In an embodiment, the antenna elements 204 may be configured to be selectively activatable and to be activated individually or in combination with two or more antenna elements.

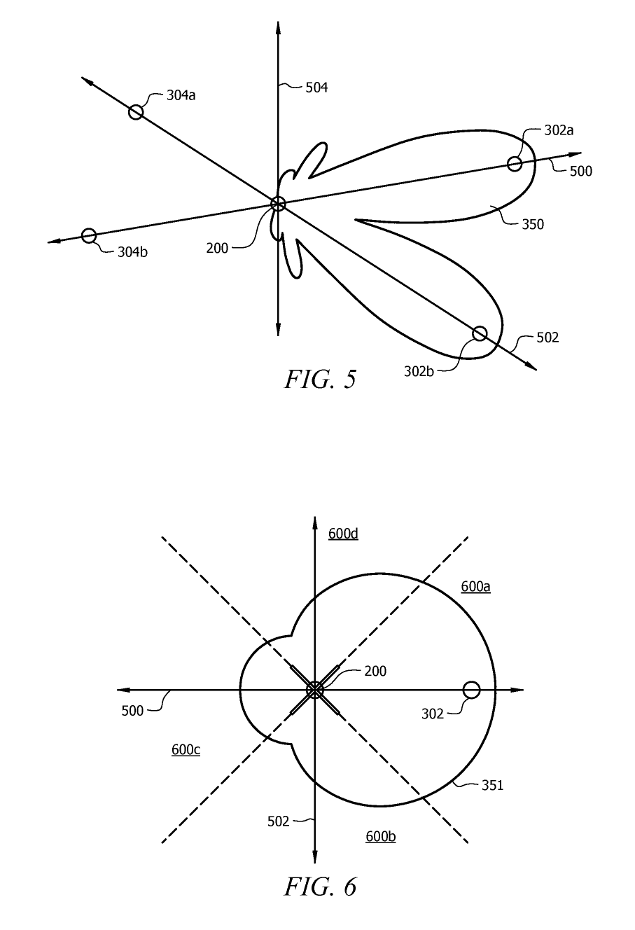

In an embodiment, the BFAA 200 may be configured to adjust and/or to steer the antenna RF pattern of the BFAA 200, for example, for targeting one or more users. Beam forming methods are well known in the art, and any suitable beam forming method may be used herewith. In an embodiment, the BFAA 200 may be configured to activate one or more antenna elements 204 in conjunction with at least a portion of the reflector 202, thereby forming an antenna RF pattern or beam within one or more sectors (e.g., sectors 510a-510d) defined by the BFAA 200 and/or the reflector 202. For example, in the embodiment of FIG. 5, the BFAA 200 may be configured to adjust an antenna RF pattern 350 towards the direction of a first target user 302a and a second target user 302b. Additionally, in such an embodiment, the BFAA 200 may be configured to substantially suppress the antenna RF pattern 350 in the direction away from the target users 302a-302b and/or in the direction of one or more non-target users 304a-304b. The use of reflectors 202 may produce better results than similar systems lacking a reflector.

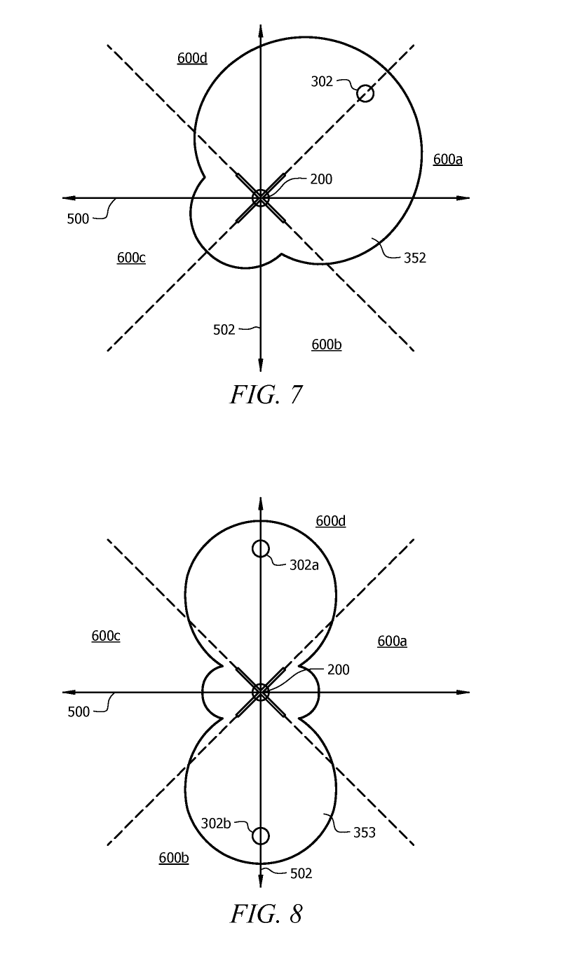

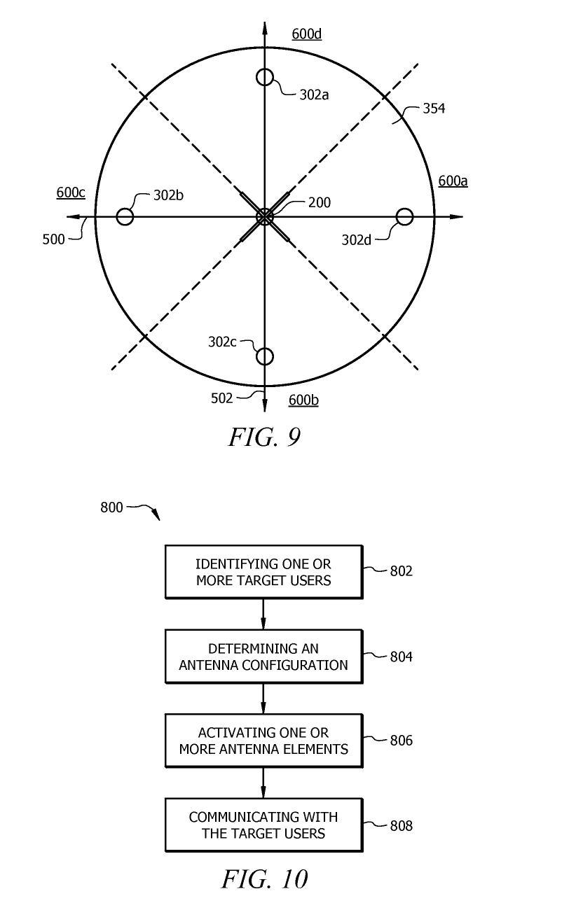

In the embodiment of FIG. 6, the BFAA 200 is configured to activate a single sector (e.g., sector 600a) of the BFAA 200 and to form an antenna RF beam 351 in the general direction of one or more target users (e.g., target user 302). For example, the BFAA 200 may be configured to interface with a plurality of switches on the transceiver 104 such that the plurality of switches selectively activates (e.g., provides electrical communication between the BFAA 200 and the transceiver 104) one or more of the antenna elements 204. Additionally, in such an embodiment, the antenna RF beam 351 may be at least partially suppressed in one or more sectors (e.g., a second sector 600b, a third sector 600c, and a fourth sector 600d) where the target user is not located. For example, one or more of the switches on the transceiver 104 may not activate one or more of the antenna elements 204. In the embodiment of FIG. 7, the BFAA 200 is configured to activate two sectors (e.g., a first sector 600a and a second sector 600d) of the BFAA 200 and to form an RF antenna beam 352 in the general direction of one or more target users (e.g., target user 302). Additionally, in such an embodiment, the antenna RF beam 351 may be at least partially suppressed in one or more sectors (e.g., a third sector 600b and a fourth sector 600c) where the target user is not located. In the embodiment of FIG. 8, the BFAA 200 is configured to activate two non-neighboring sectors (e.g., a first sector 600d and a second sector 600b) of the BFAA 200 and to form an antenna RF beam 353 directed towards two target users (e.g., a first target user 302a and a second target user 302b). Additionally, in such an embodiment, the antenna RF beam 353 may be at least partially suppressed in one or more sectors (e.g., a third sector 600c and a fourth sector 600a) where the target users are not located. In the embodiment of FIG. 9, the BFAA 200 is configured to activate all of the sectors (e.g., a first sector 600a, a second sector 600b, a third sector 600c, and a fourth sector 600d) of the BFAA 200 and to form an antenna RF beam 354 directed towards a plurality of target users (e.g., the first target user 302a, the second target user 302b, the third target user 302c, and the fourth target user 302d). In an alternative embodiment, the BFAA 200 may be configured to activate any other suitable number and/or combinations of antenna elements as would be appreciated by one of ordinary skill in the art upon viewing this disclosure.

In an embodiment, a beam forming method utilizing the BFAA 200 and/or a system comprising a BFAA 200 is disclosed herein. In an embodiment, as illustrated in FIG. 10, a beam forming method may generally comprise the steps of identifying one or more target users 802, determining an antenna configuration 804, activating one or more antenna elements 806, and communicating with the target user 808. In an additional embodiment, a beam forming method may further comprise identifying one or more additional target users, determining an antenna configuration, activating one or more antenna elements, and communicating with the target users.

When identifying the target users 802, a WLAN device and/or a BFAA, such as BFAA 200, may be provided to a location having one or more wireless broadband users (e.g., WiFi users), for example, the WLAN device and/or the BFAA 200 may be provided to a business center, an office, a hotel, a hospital, a university, and/or any other suitable location as would be appreciated by one of ordinary skill in the art. In such an embodiment, one or more of the users may be authorized to access the WLAN device. For example, one or more of the users may be able to provide and/or to transmit an authentication signal (e.g., a password or a passkey).

When determining an antenna configuration 804, the BFAA 200 may scan the surrounding environment to identify and/or to locate one or more authorized users. For example, the WLAN device may scan (e.g., activate) each of the sectors of the BFAA 200, for example, to interrogate a user and/or to listen for an RF signal (e.g., an authentication signal), thereby identifying one or more authorized target users and the relative location of the one or more authorized target users with respect to the BFAA 200.

When activating one or more antenna elements 806, the WLAN device may configure the BFAA 200 such that an antenna RF beam is formed in one or more sectors of the BFAA 200 in the general direction of the one or more authorized target users. For example, referring again to FIG. 4, the BFAA 200 activates one or more antenna elements 204 in conjunction with at least a portion of the reflector 202, thereby forming the antenna RF beam, as previously disclosed. Additionally, in such an embodiment, the WLAN device may further configure the BFAA 200 to substantially suppress an antenna RF beam in one or more sectors of the BFAA 200 not having an authorized target user.

When communicating with the target users 808, following the formation of the antenna RF beam in the general direction of the one or more authorized target users, the WLAN device and/or the BFAA 200 may establish a communication channel between the WLAN device and/or the BFAA 200 and the one or more authorized users, for example, via a CSMA protocol. In such an embodiment, following the establishing of the communication channel, the WLAN device may communicate (e.g., transmit and/or receive) an RF signal with the one or more authorized target users. For example, the WLAN device may communicate a plurality of data packets with the one or more authorized target user via the BFAA 200.

In an embodiment, the process of identifying one or more target users, determining an antenna configuration, activating one or more antenna elements, and communicating with the target users may be repeated. For example, in a manner similar to that disclosed herein, the BFAA 200 may be reconfigured to form an alternative antenna RF beam in the generally direction of the authorized target users.

In an embodiment, a BFAA 200, a system comprising a BFAA 200, and/or a beam forming method employing a system and/or a BFAA 200, as disclosed herein or in some portion thereof, may be advantageously employed during wireless communications operations. As will be appreciated by one of ordinary skill in the art, conventional methods of employing beam forming may require the use of directional antenna elements and/or one or more active circuits (e.g., amplifiers, phase shifting circuits, etc.). In an embodiment, the BFAA 200 enables an adjustable antenna RF beam without the use of directional antenna elements, phase shifting, and/or one or more active circuits (e.g., amplifiers, phase shifting circuits, etc.), as previously disclosed. For example, the WLAN device may be able to form an adjustable antenna RF beam to communicate with one or more target users while substantially suppressing the antenna RF beam in areas without a target user. Therefore, the methods disclosed herein provide a means by which the performance of the WLAN device can be improved.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term about means±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A wireless access point device comprising:
a microcontroller unit;
a transceiver coupled to the microcontroller unit; and
a beam forming antenna coupled to the transceiver, wherein the beam forming antenna comprises:
a reflector;
two or more antenna elements substantially adjacent to the reflector; and
a switch coupled to each antenna element, wherein the switch is configured to control power to the antenna elements such that a radio frequency (RF) pattern produced by the antenna elements is modified by turning on or off the antenna elements.

2. The device of claim 1, wherein the beam forming antenna is configured such that the RF pattern can be directed towards a target user by activating the switch for the antenna elements.

3. The device of claim 2, wherein the beam forming antenna is configured to provide constructive interference with the RF pattern and a reflected RF pattern.

4. The device of claim 1, wherein the reflector comprises a plurality of RF reflective surfaces.

5. The device of claim 4, wherein the plurality of RF reflective surfaces are joined to each other along a common edge.

6. The device of claim 1, wherein the reflector is arranged to be cylindrical in shape.

7. The device of claim 1, wherein the reflector is arranged to be spherical or parabolic in shape.

8. The device of claim 1, wherein one or more of the antenna elements are a dipole antenna.

9. The device of claim 1, wherein one or more of the antenna elements are a monopole antenna or a patch antenna.

10. The device of claim 1, wherein one or more of the antenna elements an omnidirectional antenna.

11. The device of claim 1, wherein the beam forming antenna is configured to be a substantially omni-directional antenna when all of the antenna elements are active.

12. The device of claim 1, wherein the antenna elements and the reflector are separated by substantially only air.

13. A beam forming method comprising:
identifying one or more target users;
determining an antenna configuration;
activating one or more antenna elements each comprising a reflector, thereby focusing an antenna radio frequency pattern towards the target users; and
communicating with the target users, thereby transmitting data to the target users or receiving data from the target users.

14. The method of claim 13, wherein activating an antenna element comprises generating an antenna radio frequency (RF) pattern in one sector, but not in another sector.

15. The method of claim 14, wherein determining the antenna configuration comprises activating the one sector and determining a location for each of the target users relative to the sector.

16. The method of claim 14, wherein focusing the antenna RF pattern towards the target users comprises activating the sector comprising the target users.

17. The method of claim 14, wherein focusing the antenna RF pattern towards the target users comprises at least partially suppressing the antenna RF pattern in the other sector, and wherein the other sector does not comprise the target users.

18. The method of claim 13, wherein focusing the antenna radio frequency (RF) pattern towards the target users comprises activating all of the sectors.

19. A wireless access point device comprising:
a microcontroller unit;
a transceiver coupled to the microcontroller unit;
a beam forming antenna coupled to the transceiver, wherein the beam forming antenna comprises:
a reflector;
two or more antenna elements substantially adjacent to the reflector; and
a switch coupled to each antenna element, wherein the switch is configured to control the power to the antenna elements such that an radio frequency (RF) pattern produced by the antenna elements is modified by turning on or off the antenna elements; and
a memory coupled to the microcontroller, wherein the memory comprises instructions that cause the microcontroller to:
identify one or more target users;
determine an antenna configuration;
activate one or more antenna elements each comprising a reflector, thereby focusing an antenna radio frequency pattern towards the target users; and
communicate with the target users, thereby transmitting data to the target users or receiving data from the target users.

20. The device of claim 19, wherein the beam forming antenna is configured such that the RF pattern can be directed towards a target user by activating the switch for the antenna elements.
